(19) United States
(12) Patent Application Publication
(10) Pub. No.: US 2026/0299470 A1
(43) Pub. Date: Oct. 1, 2026

(54) IMAGE FORMING SYSTEM, NON-TRANSITORY COMPUTER READABLE MEDIUM STORING PROGRAM, AND IMAGE FORMING METHOD

(71) Applicant: FUJIFILM Business Innovation Corp., Tokyo (JP)

(72) Inventors: Takahiro ETO, Kanagawa (JP); Kazuki IMAHORI, Kanagawa (JP)

(73) Assignee: FUJIFILM Business Innovation Corp., Tokyo (JP)

(21) Appl. No.: 19/296,992

(22) Filed: Aug. 12, 2025

(30) Foreign Application Priority Data
Mar. 25, 2025 (JP) 2025-050682

(51) Int. Cl. G03G 15/20; G03G 15/00

(52) U.S. Cl. CPC G03G 15/2039; G03G 15/2021; G03G 15/2064; G03G 15/5004; G03G 15/6585; G03G 2215/00805

(57) ABSTRACT

An image forming system includes a first heat processing unit and a second heat processing unit; a detection unit that detects a current of the first heat processing unit; and a processor configured to control power consumption of the second heat processing unit in accordance with the current of the first heat processing unit detected by the detection unit.

### CROSS-REFERENCE TO RELATED APPLICATIONS

This application is based on and claims priority under 35 USC 119 from Japanese Patent Application No. 2025-050682 filed Mar. 25, 2025.

### BACKGROUND

### (i) Technical Field

The present disclosure relates to an image forming system, a non-transitory computer readable medium storing a program, and an image forming method.

### (ii) Related Art

JP2025-005817A discloses an image forming system that prevents a current consumption in an image forming apparatus, which heats and bonds a plurality of sheets with a heater to produce a booklet, to exceed a standard value.

### SUMMARY

Various optional apparatuses such as a paper folding apparatus and a paper binding apparatus may be attached to the image forming apparatus. As one of the optional apparatuses, a secondary fixing apparatus may be used. The secondary fixing apparatus is an optional apparatus for generating glossiness on an image forming surface by further performing a fixing process on the image on a recording medium discharged from the image forming apparatus.

In a case where the secondary fixing apparatus is used, power should be supplied from one commercial power source to two heat processing units, that is, a heat processing unit in the image forming apparatus and a heat processing unit in the secondary fixing apparatus. However, the rated current that can be supplied from one system of a commercial power source is generally limited to, for example, 15 A. Therefore, in a case where the two heat processing units are operated at the maximum power consumption at the same time, the rated current may be exceeded.

Aspects of non-limiting embodiments of the present disclosure relate to an image forming system, a non-transitory computer readable medium storing a program, and an image forming method in which, in a case where a heat process is performed on a recording medium using a first heat processing unit and a second heat processing unit, it is possible to prevent the total current consumption of the first heat processing unit and the second heat processing unit from exceeding the rated current.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an image forming system including: a first heat processing unit and a second heat processing unit; a detection unit that detects a current of the first heat processing unit; and a processor configured to: control power consumption of the second heat processing unit in accordance with the current of the first heat processing unit detected by the detection unit.

### BRIEF DESCRIPTION OF THE DRAWINGS

Exemplary embodiment(s) of the present invention will be described in detail based on the following figures, wherein:

FIG. 1 is a diagram showing a configuration of an image forming system 10 according to an exemplary embodiment of the present disclosure;

FIG. 2 is a diagram for describing a power supply path to the image forming apparatus 20 and the secondary fixing apparatus 40;

FIG. 3 is a diagram showing a hardware configuration of a control unit 41 in the secondary fixing apparatus 40 according to the exemplary embodiment of the present disclosure;

FIG. 4 is a diagram showing an example of a power source waveform in a case of adjusting the power amount applied to a heat processing unit 70;

FIG. 5 is a flowchart for describing a control process of the heat processing unit 70 in the secondary fixing apparatus 40;

FIG. 6 is a flowchart for describing details of a power consumption control of the heat processing unit 70 described in step S105 of the flowchart of FIG. 5; and

FIG. 7 is a diagram showing a case where the heat processing unit 70 is configured by two heaters 71 and 72.

### DETAILED DESCRIPTION

Hereinafter, an exemplary embodiment of the present disclosure will be described in detail with reference to the drawings.

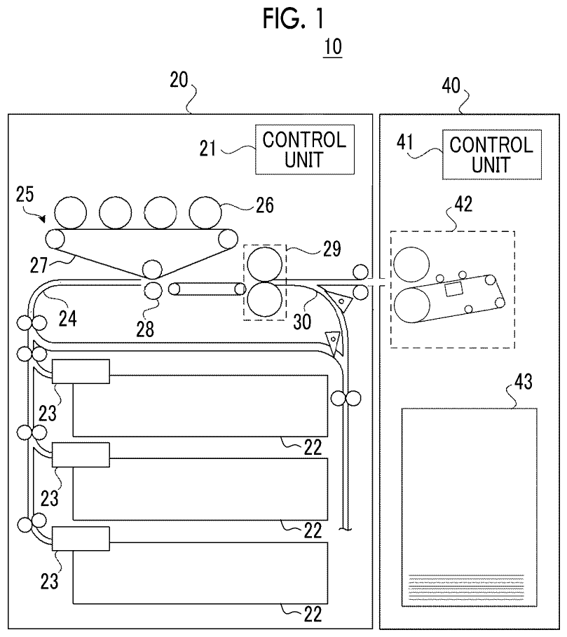

FIG. 1 is a diagram illustrating a configuration of an image forming system 10 according to the exemplary embodiment of the present disclosure.

As shown in FIG. 1, the image forming system 10 of the present exemplary embodiment is configured with an image forming apparatus 20 and a secondary fixing apparatus 40. The image forming apparatus 20 is an apparatus for forming an image on a recording medium. In addition, the secondary fixing apparatus 40 is an external apparatus that increases the glossiness amount of the image by further performing a fixing process on the image fixed on the recording medium outside the image forming apparatus 20.

The image forming apparatus 20 includes three recording medium supply cassettes 22. A supply head 23 is provided in each of the recording medium supply cassettes 22. In a case where one recording medium supply cassette 22 is selected, the supply head 23 is operated to perform supply from the selected recording medium supply cassette 22 to an image forming unit 25 via the recording medium supply path 24.

In the image forming unit 25, photoreceptors 26 of yellow, magenta, cyan, and black are arranged side by side, and an intermediate transfer belt 27 is provided. A charging device, an exposure device, a development device, a primary transfer device, a cleaning device, and the like (not shown) are disposed around each photoreceptor 26, and a toner image formed on each photoreceptor 26 is transferred to the intermediate transfer belt 27. In a case where the black and white setting is performed, only the black is operable.

The toner image on the intermediate transfer belt 27 is transferred to the recording medium sent by the secondary transfer roll 28 and is fixed by the fixing unit 29. Then, the recording medium on which the toner image is fixed is discharged to the outside through the recording medium discharge path 30. The fixing unit 29 is provided with a pressurizing roller and a heat processing unit. The pressurizing roller is heated by the heat processing unit, and the toner image is fixed to the recording medium by pressurizing and heating the toner image formed on the recording medium.

In addition, the image forming apparatus 20 includes a control unit 21. The control unit 21 controls the operation of the image forming unit 25 and the like to execute the process of forming the image on the recording medium.

The secondary fixing apparatus 40 is an optional apparatus for generating glossiness on the image forming surface by further performing the fixing process on the image on the recording medium discharged from the image forming apparatus 20.

As shown in FIG. 1, the secondary fixing apparatus 40 includes a control unit 41, a fixing unit 42, and an accommodation unit 43.

The control unit 41 communicates with the control unit 21 of the image forming apparatus 20 to understand the operation state of the image forming apparatus 20, and controls the fixing unit 42 to execute the further fixing process on the recording medium discharged from the image forming apparatus 20. The recording medium obtained after the fixing process is executed by the fixing unit 42 is accommodated in the accommodation unit 43.

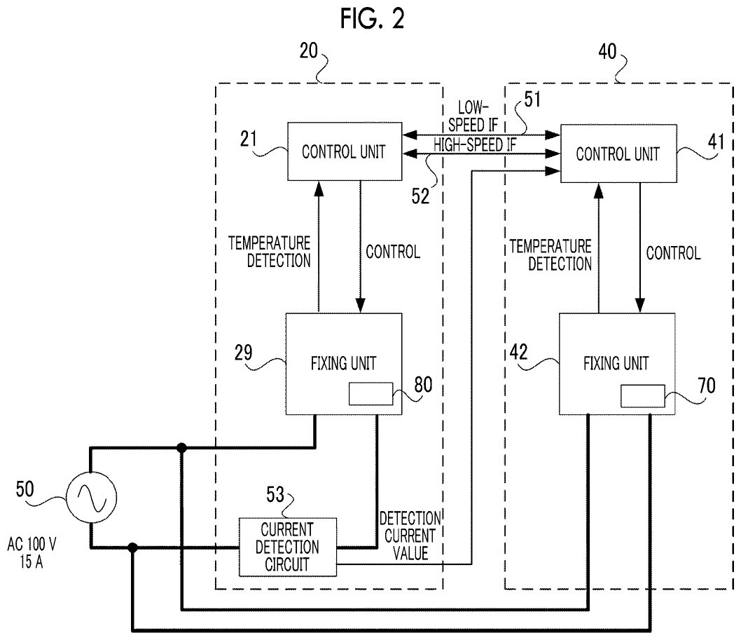

Next, a power supply path for the image forming apparatus 20 and the secondary fixing apparatus 40 will be described with reference to FIG. 2.

The image forming apparatus 20 and the secondary fixing apparatus 40 are operated by power supplied from a commercial power source 50. In the image forming apparatus 20, the control unit 21 detects the temperature of the fixing unit 29 and controls the operation of the fixing unit 29 based on the detected temperature. In addition, in the secondary fixing apparatus 40, the control unit 41 detects the temperature of the fixing unit 42 and controls the operation of the fixing unit 42 based on the detected temperature.

Here, the fixing unit 29 is provided with a heat processing unit 80. The control unit 21 controls the temperature of the fixing unit 29 by controlling the power amount applied to the heat processing unit 80. In addition, the fixing unit 42 is provided with a heat processing unit 70. The control unit 41 controls the temperature of the fixing unit 42 by controlling the power amount applied to the heat processing unit 70.

A current detection circuit 53 that detects a current consumption of the heat processing unit 80 is provided in the image forming apparatus 20. The power consumption of the heat processing unit 80 can be detected by detecting the current consumption of the heat processing unit 80. For example, in a case where the current consumption of the heat processing unit 80 is 5 A, the power consumption of the heat processing unit 80 is 500 W (5 A×100 V). That is, the current detection circuit 53 functions as a detection unit that detects the power consumption of the heat processing unit 80. The current detection circuit 53 detects the current consumption of the entire image forming apparatus 20 including not only the current consumption of the heat processing unit 80 but also the current consumption of other circuits in the image forming apparatus 20. However, the current consumption of the image forming apparatus 20 other than the heat processing unit 80 is overwhelmingly smaller than the current consumption of the heat processing unit 80. Therefore, the current consumption detected by the current detection circuit 53 will be described as being substantially the current consumption of the heat processing unit 80.

Then, the information on the detection current value of the heat processing unit 80 detected by the current detection circuit 53 is transmitted to the control unit 41 of the secondary fixing apparatus 40 via a communication line specially provided.

The control unit 21 and the control unit 41 are connected to each other by a low-speed IF 51 and a high-speed IF 52. As the low-speed IF 51, for example, low-speed command communication such as a Universal Asynchronous Receiver Transmitter (UART) is used. In addition, as the high-speed IF 52, high-speed communication such as Controller Area Network (CAN) communication is used.

Here, the secondary fixing apparatus 40 is used by being disposed in the vicinity of the image forming apparatus 20. Therefore, in a case where the secondary fixing apparatus 40 is used, power should be supplied to two heat processing units, that is, the heat processing unit 80 in the image forming apparatus 20 and the heat processing unit 70 in the secondary fixing apparatus 40, from one system of commercial power source 50. However, the rated current that can be supplied from one system of the commercial power source 50 is generally limited to, for example, 15 A. Therefore, in a case where the two heat processing units 70 and 80 are operated at the maximum power consumption at the same time, the rated current may be exceeded.

In addition, a plurality of insertion ports may be provided at one location of the outlet. However, only one wiring cable is usually connected to one outlet. A rated current that can be supplied by one wiring cable is determined. Therefore, even in a case where a plurality of insertion ports are provided at one outlet, the rated current that can be supplied from the outlet does not increase. In a general commercial power source in Japan, the rated current that can be supplied from one outlet is 15 A. That is, the rated current that can be supplied from one outlet is 15 A. In a case where a current equal to or higher than the rated current is to be used, it is necessary to supply the current from a separate system outlet or to change the outlet to an outlet capable of supplying a large current by performing electrical work.

Therefore, in the image forming system 10 of the present exemplary embodiment, the image forming apparatus 20 and the secondary fixing apparatus 40 can be operated by a current supplied from one system of the commercial power source 50 by adopting the configuration described below. Specifically, in the image forming system 10 of the present exemplary embodiment, the configuration described below is adopted, so that even in a case where the heat process is performed on the recording medium using the heat processing units 70 and 80, the total current consumption of the two heat processing units 70 and 80 is prevented from exceeding the rated current.

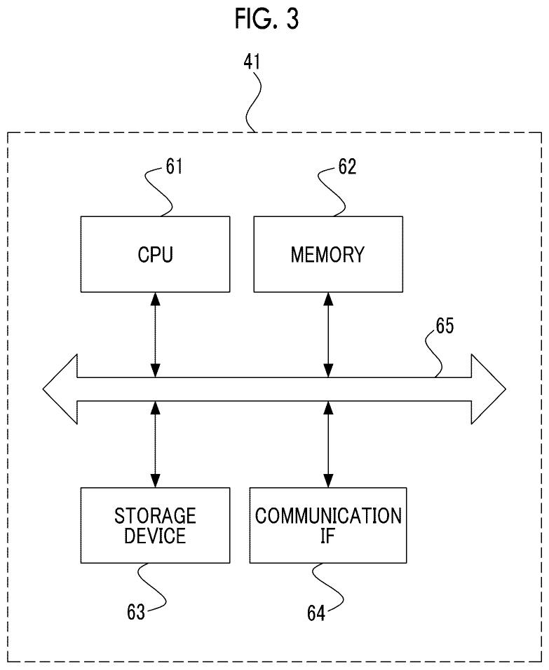

First, a hardware configuration of the control unit 41 in the secondary fixing apparatus 40 of the present exemplary embodiment is shown in FIG. 3.

As shown in FIG. 3, the control unit 41 includes a CPU 61, a memory 62, a storage device 63 such as a hard disk drive, and a communication interface (abbreviated as IF) 64 that transmits and receives data to and from an external apparatus and the like. These components are connected to each other via a control bus 65.

The CPU 61 is a processor that controls the operation of the secondary fixing apparatus 40 by executing a predetermined process based on a control program stored in the memory 62 or the storage device 63. Note that, in the present exemplary embodiment, the CPU 61 has been described to read the control program stored in the memory 62 or the storage device 63 and execute the control program. On the other hand, the present disclosure is not limited thereto. The control program may be provided in the form of being recorded on a computer-readable recording medium. For example, the program may be provided in the form of being recorded on an optical disk such as a Compact Disc (CD)-ROM and a Digital Versatile Disc (DVD)-ROM, or in the form of being recorded on a semiconductor memory such as a Universal Serial Bus (USB) memory and a memory card. Further, the control program may be acquired from the external apparatus via a communication line connected to the communication interface 64. Further, the control program may be provided, for example, as single application software or may be incorporated, as one function of the secondary fixing apparatus 40, in software of each apparatus.

The control unit 41 configured as described above controls the operation of the fixing unit 42 and the like, and thus the secondary fixing process is executed on the image formed on the recording medium.

Then, the control unit 41 controls the current consumption of the heat processing unit 70 in accordance with the current consumption of the heat processing unit detected by the current detection circuit 53.

Specifically, the control unit 41 calculates the upper limit power consumption allowable in the heat processing unit 70 by subtracting the current consumption of the heat processing unit 80 detected by the current detection circuit 53 from the rated current allowable in the image forming system 10 which is the image forming system. Then, the control unit 41 controls the heat processing unit 70 such that the heat processing unit 70 operates within the calculated upper limit power consumption.

For example, a case where the current consumption of the heat processing unit 80 detected by the current detection circuit 53 is 8 A will be described. Here, it is assumed that the current consumption in portions other than the heat processing units 70 and 80 in the image forming apparatus 20 and the secondary fixing apparatus 40 is at most 2 A. In such a case, the control unit 41 controls the heat processing unit 70 to operate within 5 A obtained by subtracting detection current values 8 A and 2 A detected by the current detection circuit 53 from the rated current 15 A of the commercial power source 50.

Then, the control unit 41 controls the heat processing unit 70 to operate within the calculated upper limit power consumption by causing the heat processing unit 70 to perform any operation of an operation using the maximum power consumption, an operation stop, or an operation of adjusting the power consumption by phase control. Here, the phase control is control of adjusting the power amount applied to a supply destination of the power source by controlling a phase, which is a timing of switching between ON and OFF, by controlling an alternating current voltage to be turned on and off using a switching element such as a Triac.

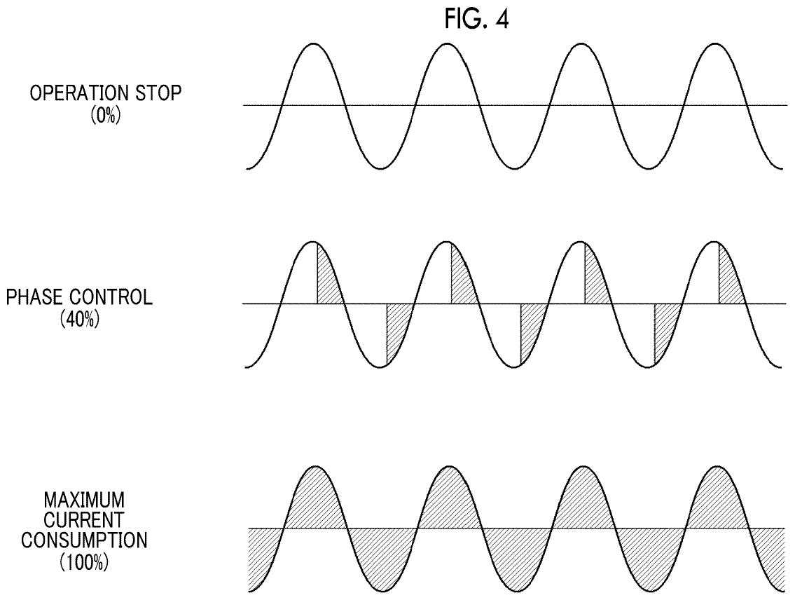

FIG. 4 shows an example of a power source waveform in a case where the power amount applied to the heat processing unit 70 is adjusted in this manner. As shown in FIG. 4, in a case where the operation of the heat processing unit 70 is stopped, the power consumption is 0% because the power source waveform is not applied to the heat processing unit 70. In addition, in a case where the heat processing unit 70 is operated at the maximum power consumption, the power consumption is 100% by applying the power source waveform that is not adjusted as it is.

In a case where the heat processing unit 70 is operated at any power consumption between 0% and 100% of the maximum power consumption, the power source waveform applied to the heat processing unit 70 is changed by the phase control. FIG. 4 shows an example of a power source waveform in a case where the heat processing unit 70 is operated at 40% of the maximum power consumption. The heat processing unit 70 can be operated at any power consumption between 0% and 100% of the maximum power consumption by changing the timing of switching between ON and OFF of the power source waveform.

Further, in a case where the heat processing unit 70 includes a plurality of heaters that can be independently controlled, the power consumption of the heat processing unit 70 can be more finely controlled by controlling the operation for each of the plurality of heaters. For example, the control unit 41 can more finely control the power consumption of the heat processing unit 70 by independently controlling the plurality of heaters and combining the phase control.

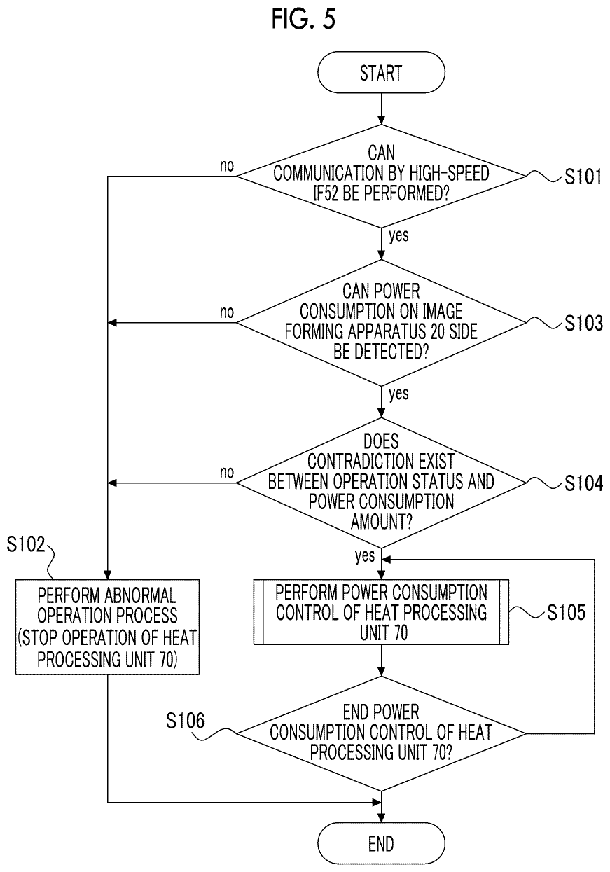

Next, a control process of the heat processing unit 70 in the secondary fixing apparatus 40 according to the present exemplary embodiment will be described in detail with reference to the flowchart of FIG. 5.

First, in step S101, the control unit 41 determines whether or not communication with the image forming apparatus 20 can be performed by the high-speed IF 52. In a case where it is determined in step S101 that the communication with the image forming apparatus 20 is not possible by the high-speed IF 52, the control unit 41 performs the abnormal operation process in step S102. Specifically, the control unit 41 performs control to stop the operation of the heat processing unit 70 such that the power consumption of the secondary fixing apparatus 40 is set to the minimum power consumption.

In a case where it is determined in step S101 that the communication with the image forming apparatus 20 is possible by high-speed IF 52, the control unit 41 determines in step S103 whether or not the power consumption on the image forming apparatus 20 side can be detected. In a case where it is determined in step S103 that the power consumption on the image forming apparatus 20 side cannot be detected, the control unit 41 performs the abnormal operation process in step S102.

Then, in a case where it is determined in step S103 that the power consumption on the image forming apparatus 20 side can be detected, the control unit 41 determines in step S104 whether or not a contradiction exists between the operation status of the image forming apparatus 20 acquired via the high-speed IF 52 and the power consumption amount detected by the current detection circuit 53. In a case where it is determined that the contradiction exists between the operation status of the image forming apparatus 20 acquired in step S104 and the detected power consumption amount, the control unit 41 performs the abnormal operation process in step S102.

In a case where it is determined that the contradiction does not exist between the operation status of the image forming apparatus 20 acquired in step S104 and the detected power consumption amount, the control unit 41 performs the power consumption control of the heat processing unit 70 in step S105.

The control unit 41 continues the power consumption control of the heat processing unit 70 in step S105 until it is determined to end the power consumption control of the heat processing unit 70 in step S106.

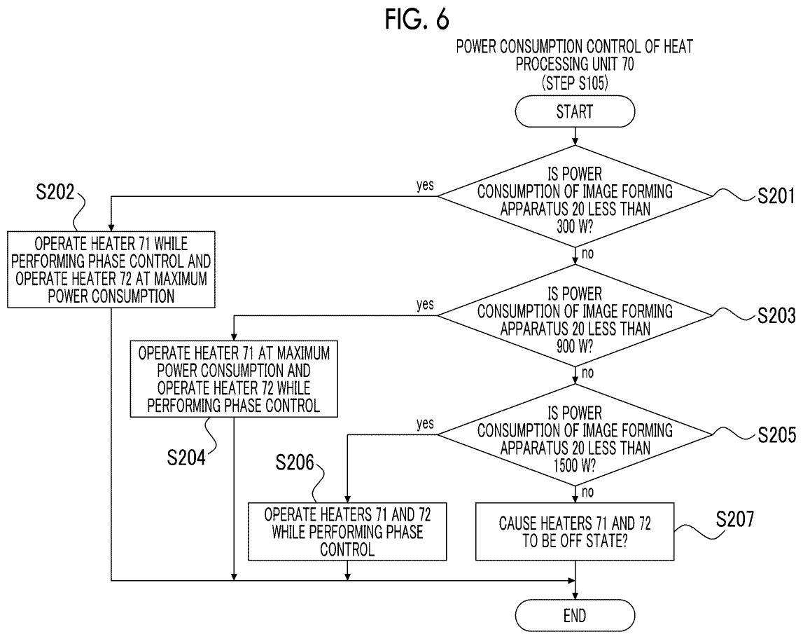

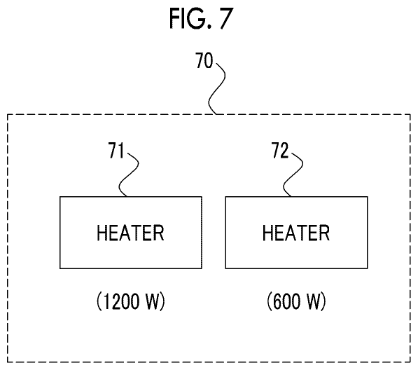

Next, details of the power consumption control of the heat processing unit 70 described in step S105 of the flowchart of FIG. 5 will be described with reference to a flowchart of FIG. 6. In the following description, a case where the heat processing unit 70 is composed of two heaters 71 and 72 as shown in FIG. 7 will be described. Here, it is assumed that the maximum power consumption of the heater 71 is 1200 W and the maximum power consumption of the heater 72 is 600 W.

The control unit 41 controls the heat processing unit 70 to operate within the calculated upper limit power consumption by switching the heater to be operated between the two heaters 71 and 72. In addition, the control unit 41 performs more detailed power consumption control by performing phase control for each of the two heaters 71 and 72 instead of independently performing the ON or OFF operation of the two heaters 71 and 72.

First, in step S201, the control unit 41 determines whether or not the current power consumption of the image forming apparatus 20 is less than 300 W based on the power consumption detected by the current detection circuit 53.

In a case where it is determined in step S201 that the current power consumption of the image forming apparatus 20 is less than 300 W, the control unit 41 operates the heater 71 while performing phase control to adjust the power consumption and operates the heater 72 at the maximum power consumption in step S202. For example, in a case where the power consumption of the image forming apparatus 20 is 150 W, the heater 71 is operated at the maximum power consumption (1200 W), and the heater 72 is operated at the power consumption (150 W) of 25% of the maximum power consumption. By performing such control, the total current consumption of the system is operated close to 15 A, which is the rated current.

In a case where it is determined in step S201 that the current power consumption of the image forming apparatus 20 is not less than 300 W, the control unit 41 determines in step S203 whether or not the current power consumption of the image forming apparatus 20 is less than 900 W.

In a case where it is determined in step S203 that the current power consumption of the image forming apparatus 20 is less than 900 W, the control unit 41 operates the heater 72 while performing phase control to adjust the power consumption and operates the heater 71 at the maximum power consumption in step S204. For example, in a case where the power consumption of the image forming apparatus 20 is 600 W, the heater 72 is operated at the maximum power consumption (600 W), and the heater 71 is operated at the power consumption (300 W) of 25% of the maximum power consumption. By performing such control, the total current consumption of the system is operated close to 15 A, which is the rated current.

In a case where it is determined in step S203 that the current power consumption of the image forming apparatus 20 is not less than 900 W, the control unit 41 determines in step S205 whether or not the current power consumption of the image forming apparatus 20 is less than 1500 W.

In a case where it is determined in step S205 that the current power consumption of the image forming apparatus 20 is less than 1500 W, the control unit 41 operates the heater 71 and the heater 72 while performing phase control to adjust the power consumption in step S206. For example, in a case where the power consumption of the image forming apparatus 20 is 1140 W, the heater 71 is operated at the power consumption (240 W) of 20% of the maximum power consumption, and the heater 72 is operated with the power consumption (120 W) of 20% of the maximum power consumption. By performing such control, the total current consumption of the system is operated close to 15 A, which is the rated current.

Then, in a case where it is determined in step S205 that the current power consumption of the image forming apparatus 20 is not less than 1500 W, the control unit 41 causes both the heaters 71 and 72 to be an OFF state in step S207.

In the present exemplary embodiment, the heat processing unit 80 is used in a fixing process of fixing an image on a recording medium in the image forming apparatus 20 that forms an image on the recording medium. In addition, the heat processing unit 70 is provided in the secondary fixing apparatus 40 that is an external apparatus that performs the heat process again on the image fixed on the recording medium outside the image forming apparatus 20. In the image forming system 10 of the present exemplary embodiment, the control unit 41 disposed in the secondary fixing apparatus 40 performs control such that the total current consumption of the entire image forming system 10 does not exceed the rated current.

Here, the secondary fixing apparatus 40 is connected to the image forming apparatus 20 as an optional apparatus later. Therefore, in the image forming apparatus 20, it is not possible to understand the extent of the maximum power consumption of the heat processing unit 70 in the secondary fixing apparatus 40. In addition, even in a case where the control unit 21 and the control unit 41 are connected to each other by the low-speed IF 51 or the high-speed IF 52 and the operation states of the control unit 21 and the control unit 41 are understood, it is difficult to understand the accurate power consumption because the situation of the power consumption used on the other side is merely predicted.

Therefore, in the present exemplary embodiment, the current detection circuit 53 is provided in the image forming apparatus 20, which is the main body side, and the control unit 41 can understand the power consumption amount in the heat processing unit 80 in the image forming apparatus 20 in real time.

Further, the control unit 21 and the control unit 41 are connected to each other by the low-speed IF 51 and the high-speed IF 52. The low-speed IF 51 is a communication line for controlling an operation timing between the image forming apparatus 20 and the secondary fixing apparatus 40.

The control unit 41 acquires information related to the operation status from the image forming apparatus 20 by using the high-speed IF 52, which is a communication line having a communication speed higher than the low-speed IF 51. Then, the control unit 41 controls the power consumption in the heat processing unit 70 by using the acquired information related to the operation status and the information on the current consumption of the heat processing unit 80 detected by the current detection circuit 53.

In a case where the control unit 21 acquires the information related to the operation status of the image forming apparatus 20 via the low-speed IF 51, there is a possibility that the operation of the image forming apparatus 20 cannot be understood in real time due to the communication delay. Therefore, the control unit 21 has to control the operation of the heat processing unit 70 with a certain margin in consideration of the communication delay. As a result, it is difficult to control the heat processing unit 70 by using the rated current of the commercial power source 50 as efficiently as possible. Therefore, there is a possibility that a problem such as a long time required for the warm-up of the heat processing unit 70 occurs, and the processing time may be increased.

Therefore, the control unit 21 acquires the information related to the operation status of the image forming apparatus 20 in real time by the high-speed IF 52 and acquires the information on the current consumption of the heat processing unit 80 in real time by the current detection circuit 53. Then, the control unit 21 can efficiently use the power up to the rated current of the commercial power source 50 by finely controlling the operation of the heat processing unit 70 based on the acquired information.

Further, by performing the control as described above, the period increased in which the total current consumption used by the image forming apparatus 20 and the secondary fixing apparatus 40 is close to 15 A, which is the rated current. As a result, the flicker and the like are also suppressed by suppressing the power fluctuation of the fluorescent lamp connected to the same power system.

In addition, in the present exemplary embodiment, since the control is closed in the secondary fixing apparatus 40 which is the optional apparatus, the power consumption can be controlled as described above without affecting the operation of the image forming apparatus 20 which is the main body side. Therefore, the secondary fixing apparatus 40 which is the optional apparatus can be easily used by being connected to the image forming apparatus 20.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

The “system” in the present exemplary embodiment includes both a system that is configured by a plurality of apparatuses and a system that is configured by a single apparatus.

The present disclosure can also be applied to a program and a program product.

### Modification Example

In the above-described exemplary embodiment, the case where the commercial power source 50 is single-phase 100 V has been described, but the technology of the present disclosure is not limited thereto. The technology of the present disclosure can be similarly applied even in a case where power is supplied to the image forming apparatus 20 and the secondary fixing apparatus 40 from a single-phase 200 V commercial power source.

### Supplementary Note

### 1

An image forming system comprising:
a first heat processing unit and a second heat processing unit;
a detection unit that detects a current of the first heat processing unit; and
a processor configured to:
   control power consumption of the second heat processing unit in accordance with the current of the first heat processing unit detected by the detection unit.

### 2

The image forming system according to (((1))), wherein the processor is configured to:
calculate an upper limit power consumption allowable in the second heat processing unit by subtracting the current of the first heat processing unit detected by the detection unit from a rated current allowable in the image forming system, and control the second heat processing unit to operate within the calculated upper limit power consumption.

### 3

The image forming system according to (((2))), wherein the processor is configured to:
control the second heat processing unit to operate within the upper limit power consumption calculated by causing the second heat processing unit to perform any operation of an operation using maximum power consumption, an operation stop, or an operation of adjusting power consumption by phase control.

### 4

The image forming system according to (((2))),
wherein the second heat processing unit includes a plurality of heaters, and
the processor is configured to:
   control the second heat processing unit to operate within the calculated upper limit power consumption by switching a heater to be operated among the plurality of heaters.

### 5

The image forming system according to any one of (((1))) to (((4))),
wherein the first heat processing unit is used for a fixing process of fixing an image on a recording medium in an image forming apparatus that forms the image on the recording medium,
the second heat processing unit is provided in an external apparatus that performs a heat process on the image fixed on the recording medium outside the image forming apparatus, and
the processor is configured to be disposed in the external apparatus.

### 6

The image forming system according to (((5))),
wherein the external apparatus is a secondary fixing apparatus that increases a glossiness amount of the image by further performing the fixing process on the image fixed on the recording medium outside the image forming apparatus.

### 7

The image forming system according to (((5))) or (((6))), wherein the processor is configured to:
acquire information related to an operation status from the image forming apparatus by using a second communication line having a higher communication speed than a first communication line for controlling an operation timing with the image forming apparatus, and
control the power consumption in the second heat processing unit by using the acquired information related to the operation status and information related to the power consumption of the first heat processing unit detected by the detection unit.

### 8

A program causing a computer to execute a process for controlling an operation of an image forming system including a first heat processing unit and a second heat processing unit, and a detection unit that detects a current of the first heat processing unit, the process comprising:
acquiring information on current in the first heat processing unit; and
controlling power consumption of the second heat processing unit in accordance with the current of the first heat processing unit.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming system comprising:
a first heat processing unit and a second heat processing unit;
a detection unit that detects a current of the first heat processing unit; and
a processor configured to:
control power consumption of the second heat processing unit in accordance with the current of the first heat processing unit detected by the detection unit.

2. The image forming system according to claim 1, wherein the processor is configured to:
calculate an upper limit power consumption allowable in the second heat processing unit by subtracting the current of the first heat processing unit detected by the detection unit from a rated current allowable in the image forming system, and
control the second heat processing unit to operate within the calculated upper limit power consumption.

3. The image forming system according to claim 2, wherein the processor is configured to:
control the second heat processing unit to operate within the upper limit power consumption calculated by causing the second heat processing unit to perform any operation of an operation using maximum power consumption, an operation stop, or an operation of adjusting power consumption by phase control.

4. The image forming system according to claim 2,
wherein the second heat processing unit includes a plurality of heaters, and
the processor is configured to:
control the second heat processing unit to operate within the calculated upper limit power consumption by switching a heater to be operated among the plurality of heaters.

5. The image forming system according to claim 1,
wherein the first heat processing unit is used for a fixing process of fixing an image on a recording medium in an image forming apparatus that forms the image on the recording medium,
the second heat processing unit is provided in an external apparatus that performs a heat process on the image fixed on the recording medium outside the image forming apparatus, and
the processor is configured to be disposed in the external apparatus.

6. The image forming system according to claim 5,
wherein the external apparatus is a secondary fixing apparatus that increases a glossiness amount of the image by further performing the fixing process on the image fixed on the recording medium outside the image forming apparatus.

7. The image forming system according to claim 5, wherein the processor is configured to:
acquire information related to an operation status from the image forming apparatus by using a second communication line having a higher communication speed than a first communication line for controlling an operation timing with the image forming apparatus, and
control the power consumption in the second heat processing unit by using the acquired information related to the operation status and information related to the power consumption of the first heat processing unit detected by the detection unit.

8. A non-transitory computer readable medium storing a program causing a computer to execute a process for controlling an operation of an image forming system including a first heat processing unit and a second heat processing unit, and a detection unit that detects a current of the first heat processing unit, the process comprising:
acquiring information on current in the first heat processing unit; and
controlling power consumption of the second heat processing unit in accordance with the current of the first heat processing unit.

9. An image forming method comprising:
acquiring information on current in a first heat processing unit; and
controlling power consumption of a second heat processing unit in accordance with the acquired current of the first heat processing unit.
